(19) United States
(12) Patent Application Publication
(10) Pub. No.: US 2014/0278110 A1
(43) Pub. Date: Sep. 18, 2014

(54) TARGETED SURVEY DESIGN UNDER UNCERTAINTY

(71) Applicant: SCHLUMBERGER TECHNOLOGY CORPORATION, Sugar Land, TX (US)

(72) Inventors: NIKITA CHUGUNOV, ARLINGTON, MA (US); TERIZHANDUR S. RAMAKRISHNAN, BOXBOROUGH, MA (US); NICOLAE MOLDOVEANU, HOUSTON, TX (US); AIMÉ FOURNIER, HOUSTON, TX (US); KONSTANTIN S. OSYPOV, HOUSTON, TX (US); YUSUF BILGIN ALTUNDAS, BELMONT, MA (US)

(73) Assignee: SCHLUMBERGER TECHNOLOGY CORPORATION, Sugar Land, TX (US)

(21) Appl. No.: 14/207,021

(22) Filed: Mar. 12, 2014

Related U.S. Application Data
(60) Provisional application No. 61/791,954, filed on Mar. 15, 2013.

(51) Int. Cl. G01V 11/00

(52) U.S. Cl. CPC G01V 11/002
USPC 702/6

(57) ABSTRACT

A method, apparatus, and program product utilize global sensitivity analysis (GSA) based on variance decomposition to calculate and apportion the contributions to a total variance of a measurement signal from uncertain input parameters of a subsurface model in connection with designing targeted surveys. Through the use of global sensitivity analysis in this manner, the geometry for a survey may be determined based on a desired target of the design, e.g., based on spatial properties (e.g., reservoir zone of interest) and/or physical properties (e.g., porosity, fluid density, rock physics properties) to select locations (e.g., source-receiver pairs) with greater uncertainty contributions from parameter group(s) of interest.

### CROSS-REFERENCE TO RELATED APPLICATION

This application claims the benefit of U.S. Provisional Patent Application Ser. No. 61/791,954 filed on Mar. 15, 2013, which is incorporated herein by reference in its entirety.

### BACKGROUND

Uncertainty analysis is routinely used in the oil and gas industry to address the uncertainty that is inherent in the data used to simulate the properties of oil and gas reservoirs. The main source of uncertainty is often due to limited available information about reservoir properties such as porosity, permeability, fluid saturations and their spatial distribution, lithology and multiphase flow characteristics. This uncertainty may be quantified based on available limited data (indirect measurements with limited spatial resolution, e.g., seismic, electromagnetic, gravity surveys). Quantified uncertainty can be propagated through available forward models including reservoir simulations and forward measurement models. Subsequent business decisions are made based on the predicted quality metric or performance of the reservoir and associated uncertainties.

Propagation of reservoir uncertainty into monitoring program design is an active area of research, and often incorporates optimal experimental design and Bayesian approaches to maximize expected information from measurements (e.g., reduce uncertainty in posterior model) by locating design points in the areas with the highest variance of the measurement signal. Generally, the measurement data in these approaches are related to the subsurface property via sensitivity matrices with elements calculated by taking first- or second-order derivatives.

One area, however, where such approaches fall short is in quantifying the link between the predicted measurement variance and the variance of specific uncertain reservoir properties. Quantifying this link, however, may contribute to optimal survey design, and in particular the determination of optimal locations of sources and receivers for various types of large-scale measurement surveys, e.g., seismic, electromagnetic, and other geophysical surveys where source devices disposed at locations in a geographical region transmit signals into a subterranean formation and receiver devices disposed at different locations receive the signals, or reflections of the signals, so that the received data can be analyzed to measure properties of the subterranean formation.

For these types of surveys, the probed region often includes both reservoir and non-reservoir zones, and the locations of sources and receivers can have an impact on the quality and usefulness of the collected data. Conventional approaches to recommending locations of sources and receivers when designing a survey, however, generally produce design recommendations based on the total variance of predicted measurement signals and do not have an ability to identify any sources of this variance. As a result, recommendations using conventional approaches are often sub-optimal, especially when technical and economic constraints are taken into account.

Therefore, a need continues to exist in the art for an improved method of addressing uncertainty in connection with survey design.

### SUMMARY

The embodiments disclosed herein provide a method, apparatus, and program product that utilize global sensitivity analysis (GSA) based on variance decomposition to calculate and apportion the contributions to the total variance of a measurement signal from uncertain input parameters of a subsurface model in connection with designing targeted surveys. Through the use of GSA in this manner, a geometry for a survey, e.g., a source-receiver geometry, may be determined based on a desired target of the design, e.g., based on spatial properties (e.g., reservoir zone of interest) and/or physical properties (e.g., porosity, fluid density, rock physics properties) to select source-receiver pairs with greater uncertainty contributions from parameter group(s) of interest.

In accordance with some embodiments, a method of designing a targeted survey is performed that includes using at least one processor, determining a total variance of a measurement signal at a plurality of locations in a geographical region from a subsurface model; using the at least one processor, performing global sensitivity analysis to determine individual contributions of a plurality of uncertain parameter groups to the total variance of the measurement signal at the plurality of locations; and determining a geometry for a survey based on the determined individual contributions.

In accordance with some embodiments, an apparatus is provided that includes at least one processor; and program code configured upon execution by the at least one processor to design a targeted survey by determining a total variance of a measurement signal at a plurality of locations in a geographical region from a subsurface model; performing global sensitivity analysis to determine individual contributions of a plurality of uncertain parameter groups to the total variance of the measurement signal at the plurality of locations; and determining a geometry for a survey based on the determined individual contributions.

In accordance with some embodiments, a program product is provided that includes a computer readable medium; and program code stored on the computer readable medium and configured upon execution by at least one processor to design a targeted survey by determining a total variance of a measurement signal at a plurality of locations in a geographical region from a subsurface model; performing global sensitivity analysis to determine individual contributions of a plurality of uncertain parameter groups to the total variance of the measurement signal at the plurality of locations; and determining a geometry for a survey based on the determined individual contributions.

In accordance with some embodiments, an apparatus is provided that includes at least one processor, program code and means for designing a targeted survey by determining a total variance of a measurement signal at a plurality of locations in a geographical region from a subsurface model; performing global sensitivity analysis to determine individual contributions of a plurality of uncertain parameter groups to the total variance of the measurement signal at the plurality of locations; and determining a geometry for a survey based on the determined individual contributions.

In accordance with some embodiments, an information processing apparatus for use in a computing system is provided, and includes means for designing a targeted survey by determining a total variance of a measurement signal at a plurality of locations in a geographical region from a subsurface model; performing global sensitivity analysis to determine individual contributions of a plurality of uncertain parameter groups to the total variance of the measurement signal at the plurality of locations; and determining a geometry for a survey based on the determined individual contributions.

In some embodiments, an aspect of the invention includes that determining the geometry for the survey comprises determining a total variance of a performance metric of a project from the subsurface model; performing global sensitivity analysis for the performance metric of the project to identify individual contributions of a second plurality of uncertain parameter groups to the total variance of the performance metric of the project; and determining a geometry for a survey based on the identified second plurality of uncertain parameter groups contributing to the total variance of the performance metric of the project.

In some embodiments, an aspect of the invention includes that the performance metric is net present value (NPV), total hydrocarbon in place, or total hydrocarbon produced.

In some embodiments, an aspect of the invention includes that determining the geometry based on the determined individual contributions includes determining the geometry based on a target.

In some embodiments, an aspect of the invention includes that the target is a spatial parameter.

In some embodiments, an aspect of the invention includes that the spatial parameter is a subsurface zone of interest.

In some embodiments, an aspect of the invention includes that the target is a physical parameter.

In some embodiments, an aspect of the invention includes that the physical parameter comprises porosity, permeability, elastic properties, residual saturations, fluid density, or combinations thereof.

In some embodiments, an aspect of the invention includes that the target is a combination of a spatial parameter and a physical parameter.

In some embodiments, an aspect of the invention includes that at least one parameter group is associated with a spatial parameter.

In some embodiments, an aspect of the invention includes that at least one parameter group is associated with a physical parameter.

In some embodiments, an aspect of the invention includes that at least one parameter group is associated with a physical parameter and a spatial parameter.

In some embodiments, an aspect of the invention includes that determining the geometry based on the determined individual contributions includes selecting a first source-receiver pair over a second source-receiver pair based upon the first source-receiver pair having a higher individual contribution to the total variance associated with the target than the second source-receiver pair.

In some embodiments, an aspect of the invention includes generating a visualization of the individual contributions.

In some embodiments, an aspect of the invention includes that the visualization includes a color map.

In some embodiments, an aspect of the invention includes that the visualization includes at least one pie-diagram displaying relative individual contributions at a first location.

In some embodiments, an aspect of the invention includes that determining the geometry for the survey includes determining a source-receiver geometry for the survey.

In some embodiments, an aspect of the invention includes that determining the geometry for the survey includes determining a geometry for each of a plurality of surveys, that each of the plurality of surveys is a geophysical or a petrophysical survey, and that the plurality of surveys are performed simultaneously or at different times.

In some embodiments, an aspect of the invention includes performing the survey based on the determined geometry.

In some embodiments, an aspect of the invention includes that the survey is a Vertical Seismic Profile (VSP) survey, a three dimensional (3D) VSP survey, a surface-to-borehole electro-magnetic survey, a gravimetry survey, a gradiometry survey, or an interferometric synthetic aperture radar survey.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 is an example color graph for use in connection with some embodiments of a spatially targeted survey design consistent with the invention.

FIG. 6 is an example graph illustrating the calculation of a number of hits per grid cell (bin) based on 3D ray tracing using a given acquisition geometry.

FIG. 7 is an example color graph for use in connection with some embodiments of a physical property targeted survey design consistent with the invention.

FIG. 8 is a flowchart illustrating an example sequence of operations for performing a targeted survey design consistent with some embodiments of the invention.

### DETAILED DESCRIPTION

The herein-described embodiments are generally directed to the design of targeted measurement surveys under uncertainty, and the techniques disclosed herein may be used independently or in conjunction with conventional survey design approaches.

In some embodiments consistent with the invention, the uncertainty of the subsurface properties may be propagated through a subsurface model and a forward measurement model and represented in the form of variance of the predicted measurement signal. Global sensitivity analysis (GSA) based on variance decomposition is used to calculate and apportion the contributions to the total variance of the measurement signal from the uncertain input parameters, and in particular groups of uncertain input parameters, of the subsurface model.

Uncertain input parameters may be grouped spatially (e.g., overburden zone A, overburden zone B, reservoir zone C, reservoir zone D) or by underlying physics (e.g., porosity, fluid density, rock physics properties) to form a plurality of uncertain parameter groups, each of which including one or more uncertain input parameters. Desired geometry (e.g., a source-receiver geometry, a source geometry, a receiver geometry, etc.) may then be determined based on the target of the design (e.g., reservoir zone of interest, physical property of interest, or a combination of thereof). For a source-receiver geometry, as an example, a desired geometry may be determined by selecting the source-receiver pairs based upon the uncertainty contributions from an uncertain parameter group of interest. In some embodiments, for example, those source-receiver pairs having the highest or greatest uncertainty contributions may be selected. For other geometries (e.g., source geometries or receiver geometries), individual source or receiver locations, as appropriate, may be selected.

When used in conjunction with other survey design approaches, the herein-disclosed techniques provide a quantitative basis to accept/reject suggested survey points or source-receiver pairs. Applications of the herein-described techniques include design of seismic, electromagnetic, gravity and other geophysical surveys both at the exploration (static model) and at the operation (dynamic model) stages.

Other variations and modifications will be apparent to one of ordinary skill in the art. Examples of applications at the operation (dynamic model) stage are given in Chugunov N., Altundas Y. B., Ramakrishnan T. S., Senel O., Global sensitivity analysis for crosswell seismic and nuclear measurements in CO₂ storage projects, Geophysics, Vol. 78, No. 3 (May-June 2013), pp. WB77-WB87 and Chugunov N., Senel O., Ramakrishnan T. S., Reducing Uncertainty in Reservoir Model Predictions: from Plume Evolution to Tool Responses, Presented at the 11th International Conference on Greenhouse Gas Control Technologies (GHGT-11), Kyoto, Japan, Nov. 16-22, 2012 (published in Energy Procedia, Volume 37, 2013, Pages 3687-3698). Both references are incorporated in this application in their entirety.

In addition, as will become more apparent below, the techniques disclosed herein may be applicable to a wide variety of surveys, including various geophysical and petrophysical surveys. For example, the techniques disclosed herein may be applicable to surveys where either the source or the receiver is fixed (e.g., Vertical Seismic Profile (VSP), 3D VSP, surface-to-borehole electro-magnetic surveys), or surveys where only receivers are used (e.g., gravimetry and gradiometry, interferometric synthetic aperture radar—InSAR). Other applicable types of surveys will be apparent to one of ordinary skill in the art having the benefit of the instant disclosure, and as such, the geometry of a targeted survey design is not limited to a source-receiver geometry based upon source-receiver pairs.

### Hardware and Software Environment

Turning now to the drawings, wherein like numbers denote like parts throughout the several views, FIG. 1 illustrates an example data processing system 10 in which the various technologies and techniques described herein may be implemented. System 10 is illustrated as including one or more computers 11, e.g., client computers, each including a central processing unit 12 including at least one hardware-based microprocessor coupled to a memory 14, which may represent the random access memory (RAM) devices comprising the main storage of a computer 11, as well as any supplemental levels of memory, e.g., cache memories, non-volatile or backup memories (e.g., programmable or flash memories), read-only memories. In addition, memory 14 may be considered to include memory storage physically located elsewhere in a computer 11, e.g., any cache memory in a microprocessor, as well as any storage capacity used as a virtual memory, e.g., as stored on a mass storage device 16 or on another computer coupled to a computer 11.

Each computer 11 also receives a number of inputs and outputs for communicating information externally. For interface with a user or operator, a computer 11 includes a user interface 18 incorporating one or more user input devices, e.g., a keyboard, a pointing device, a display, a printer. Otherwise, user input may be received, e.g., over a network interface 20 coupled to a network 22, from one or more servers 24. A computer 11 also may be in communication with one or more mass storage devices 16, which may be, for example, internal hard disk storage devices, external hard disk storage devices, storage area network devices, etc.

A computer 11 operates under the control of an operating system 26 and executes or otherwise relies upon various computer software applications, components, programs, objects, modules, data structures, etc. For example, a targeted survey design application 28 may be used to generate targeted surveys. Application 28 may interface with a petro-technical modeling platform 30, which may include a database 32 within which may be stored modeling data 34. Platform 30 and/or database 32 may be implemented using multiple servers 24 in some implementations, and it will be appreciated that each server 24 may incorporate processors, memory, and other hardware components similar to a client computer 11.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code comprises one or more instructions that are resident at various times in various memory and storage devices in a computer, and that, when read and executed by one or more processors in a computer, cause that computer to execute steps or elements embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets), it should be appreciated that the invention is not limited to the specific organization and allocation of program functionality described herein. [0079]

It will be appreciated that the terminology used herein is for the purpose of describing particular embodiments only and is not intended to be limiting of the embodiments of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Furthermore, to the extent that the terms “includes,” “having,” “has,” “with,” “comprised of,” or variants thereof are used in either the detailed description or the claims, such terms are intended to be inclusive in a manner similar to the term “comprising.” In addition, it will be appreciated that the operations represented by blocks of any flowcharts included herein may be reorganized, performed concurrently, and/or sequentially in any order, and that some operations may be combined, reordered, omitted, and/or supplemented with other techniques known in the art.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

FIGS. 2a-2d illustrate simplified, schematic views of an oilfield 100 having subterranean formation 102 containing reservoir 104 therein in accordance with implementations of various technologies and techniques described herein. FIG. 2a illustrates a survey operation being performed by a survey tool, such as seismic truck 106.1, to measure properties of the subterranean formation. The survey operation is a seismic survey operation for producing sound vibrations. In FIG. 2a, one such sound vibration, sound vibration 112 generated by source 110, reflects off horizons 114 in earth formation 116. A set of sound vibrations is received by sensors, such as geophone-receivers 118, situated on the earth's surface. The data received 120 are provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2b illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2c illustrates a wireline operation being performed by wireline tool 106.3 suspended by rig 128 and into wellbore 136 of FIG. 2b. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2a. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2d illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2b-2d illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2a-2d are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2a-2d, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that provides a resistivity or other measurement of the formation at various depths.

A production decline curve or graph 208.4 is a dynamic data plot of the fluid flow rate over time. The production decline curve provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations (e.g., below the water line), fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 may be used by a geophysicist to determine characteristics of the subterranean formations and features. The core data shown in static plot 208.2 and/or log data from well log 208.3 are used by a geologist to determine various characteristics of the subterranean formation. The production data from graph 208.4 is used by the reservoir engineer to determine fluid flow reservoir characteristics. The data analyzed by the geologist, geophysicist and the reservoir engineer may be analyzed using modeling techniques.

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Targeted Survey Design Under Uncertainty

Embodiments consistent with the invention determine a desired geometry for a targeted survey by performing global sensitivity analysis (GSA) to determine individual contributions of a plurality of uncertain parameter groups to a total variance of a measurement signal at a plurality of locations in a geographical region. Total variance, in this regard, may be considered to represent a variance related to the contributions of at least multiple uncertain parameter groups. In some embodiments, however, other contributions may be incorporated into the total variance beyond those of the uncertain parameter groups under consideration, while in other embodiments, the total variance may be based solely on the contributions of the uncertain parameter groups under consideration. Therefore, a “total variance” in various embodiments may include or exclude some of the contributions to a calculated uncertainty in a measurement signal.

In some embodiments, the geometry may be a source-receiver geometry where the locations under consideration are associated with source-receiver pairs, and may be representative of the location of a source, a receiver, or both. As other types of geometries may be associated with a survey, the invention is therefore not limited to the source-receiver geometries discussed hereinafter.

Uncertain parameter groups, as noted above, may be based on spatial grouping (e.g., overburden zone A, overburden zone B, reservoir zone C, reservoir zone D) and/or by physical-property grouping (e.g., porosity, fluid density, rock physics properties), such that a desired source-receiver geometry may be determined based on the target of a design (e.g., reservoir zone of interest, physical property of interest, or a combination of thereof) by selecting the source-receiver pairs based upon the uncertainty contributions from one or more uncertain parameter groups of interest. Prior to addressing embodiments relying on spatial and/or physical property groupings, an overview of the determination of uncertainty contributions is provided below.

In the illustrated embodiments, the uncertainty of subsurface properties X={Xᵢ} may be expressed via probability distribution functions and propagated through the subsurface model and a forward measurement model. The resulting statistics for a given source-receiver pair may be represented in the form of variance of the predicted measurement signal as V(Y).

GSA based on variance decomposition may be used to calculate and apportion the contributions to the variance of the measurement signal V(Y) from the uncertain input parameters {Xᵢ} of the subsurface model.

For independent {Xᵢ}, a Sobol variance decomposition may be used to represent V(Y) as:

V(Y)=Σᵢ₌₁^{N}Vᵢ+Σ_{1≦i<j≦N}Vᵢⱼ+ . . . +V_{12 . . . N}, (1)

where Vᵢ=V[E(Y|Xᵢ)] are the variances in conditional expectations (E) representing first-order contributions to the total variance V(Y) when Xᵢ is fixed, i.e., Vᵢ(Xᵢ)=0. Since the true value of Xᵢ is known a priori, the expected value of Y when Xᵢ is fixed anywhere within its possible range may be estimated, while the rest of the input parameters X_{˜i}={X_{˜i}} are varied according to their original probability distributions. Thus,

S1ᵢ=Vᵢ/V(Y) (2)

is an estimate of relative reduction in total variance of Y if the variance in Xᵢ is reduced to zero.

Similarly, Vᵢⱼ=V[E(Y|Xᵢ, Xⱼ)]−Vᵢ−Vⱼ is the second-order contribution to the total variance V(Y) due to interaction between Xᵢ and Xⱼ. It should be noted that the estimate of variance V[E(Y|Xᵢ, Xⱼ)] when both Xᵢ and Xⱼ are fixed simultaneously may be corrected for individual contributions by Vᵢ and Vⱼ.

For additive models Y(X), the sum of all first-order effects S1ᵢ is equal to 1. This is generally not applicable for the general case of non-additive models, where second, third and higher-order effects (i.e., interactions between two, three or more input parameters) also play a role. The contribution due to higher-order effects may be estimated via total sensitivity index ST:

STᵢ={V(Y)−V[E(Y|X_{˜i})]}/V(Y), (3)

where V(Y)−V[E(Y|X_{˜i})] is the total variance contribution from all terms in Eq. (1) that includes Xᵢ. STᵢ≧S1ᵢ, and the difference between the two represents the contribution from the higher-order interaction effects that include Xᵢ.

Various methods may be used to estimate S1ᵢ and STᵢ. For example, in some embodiments any of the algorithms disclosed in Saltelli A., Tarantola S., Campolongo, F. and Ratto, M., Sensitivity Analysis in Practice, A Guide to Assessing Scientific Models, John Wiley & Sons publishers, 2004 may be used, and in some embodiments may be used to further extend a computational approach proposed in Sobol I. M. “Global sensitivity indices for nonlinear mathematical models and their Monte Carlo estimates,” Math Comput Simul 55:271-280, 2001, or Homma T., and A. Saltelli, “Importance measures in global sensitivity analysis of model output”, Reliability Engineering and System Safety, 52(1): 1-17, 1996. All of the aforementioned publications are hereby incorporated by reference herein in their entireties.

The computational cost of calculating both S1ᵢ and STᵢ using this algorithm is generally of order kx(N+2), where N is the number of input parameters {Xᵢ} and k is a large enough number of model calls (generally between 1000 and 10000) to obtain an accurate estimate of conditional means and variances. However, with reservoir simulators taking several hours for one run, this computational cost may be prohibitively high for some applications. Therefore, it may be desirable in some embodiments to use proxy-models that approximate computationally expensive original simulators. In some embodiments, proxy-models may be constructed using methods and algorithms disclosed in Storlie, C. B., Swiler L. P., Helton J. C., and Sallaberry C. J. 2009, Implementation and Evaluation of Nonparametric Regression Procedures for Sensitivity Analysis of Computationally Demanding Models, Reliability Engineering and System Safety, 94 (11), 1735-1763, which is incorporated by reference herein in its entirety.

An alternative approach for calculating GSA indices may be based on Polynomial Chaos Expansion, where GSA sensitivity indices of all orders can be calculated explicitly from coefficients of model projection on orthogonal polynomial basis. An example of this approach is disclosed in Sudret B. 2008, Global sensitivity analysis using polynomial chaos expansion, Reliability Engineering & System Safety Vol. 93, Issue 7, pp. 964-979, which is incorporated by reference herein in its entirety.

### Spatially Targeted Design

As noted above, in some embodiments, spatial groupings and targets may be used to optimize a survey design. It is not uncommon for a reservoir to be represented by hundreds of thousands to several million grid cells. In one embodiment, the input parameters {Xᵢ} may be grouped spatially (e.g., overburden zone A, overburden zone B, reservoir zone C, reservoir zone D). For example, in one simple case, let all {Xᵢ} from all reservoir zones be denoted as Ω, and all {Xᵢ} from all non-reservoir zones be denoted as Λ. The corresponding first-order sensitivity indices for these meta-parameters may then be calculated as:

S1_{Ω}=V[E(Y|Ω)]/V(Y), (4)

S1_{Λ}=V[E(Y|Λ)]/V(Y), (5)

respectively for reservoir (Ω) and non-reservoir (Λ) zones.

Therefore, for each source-receiver pair, along with the total variance of the measurement signal, an individual contribution to this variance due to uncertainty in reservoir properties and non-reservoir zones becomes available. This information may be used to determine the geometry of the design targeting the reservoir zone. Combined with the cost function for each measurement pair, the herein-described method may be used to design the survey under technical and economic constraints for a particular site.

If used in conjunction with other survey design approaches, the herein-described techniques provide quantitative basis to accept/reject suggested survey points. In addition, the herein-described techniques may provide flexibility to introduce as many spatial groupings (e.g., including groupings representing sub-groups of spatial zones such as sub-regions of a reservoir zone) as desired, thus allowing one to design the survey targeting a specific subsurface zone. An illustrative example showing an answer product for this method is presented in FIG. 5.

A color map 400 in FIG. 5 represents the variance calculated for travel times between a given source and receiver (in this case, both source and receivers are located at the surface). The areas with higher variance are indicated at 402, while the low variance areas are indicated at 404. Dots 406 indicate possible locations of the receivers. While with conventional approaches, no further criterion would be applied than maximum overall variance, in the illustrated embodiments, for each candidate location, GSA may be performed in the various manners discussed above to calculate an individual contribution to the total variance of the travel times coming from uncertainties in the pre-defined spatial zones. For example, in the example illustrated in FIG. 5, the overburden may be subdivided into two zones: Overburden A and Overburden B, with the reservoir represented by a single meta-parameter group.

Through the application of GSA, an individual contribution may be calculated for each of these groups. As shown in FIG. 5, for example, pie-diagrams 408a-d, or other suitable charts such as bar graphs, line graphs, etc., may be used to represent the individual contributions from a reservoir zone 410, overburden A zone 412 and overburden B zone 414. Thus, based on the data visualized in FIG. 5, the locations associated with pie-diagrams 408c and 408d would generally be considered more desirable candidates (assuming the survey is concerned with the reservoir) than those associated with pie-diagrams 408a and 408b based upon the reservoir's relatively higher contribution to the overall variances.

As another example, one attribute that could be estimated based on 3D ray tracing is the number of hits corresponding to each source/receiver pair that generates a reflection from the target (FIG. 6). The hit points may be binned in a predefined grid, and for each cell grid (bin) the number of hits may be calculated. For each bin one can make a calculation,

$$S = {\sum }_{i = 1}^{n} a ( i ) ,$$

where a(i) are the amplitude values associated to each hit, and n is number of hits per bin. The quantity s may be associated with the signal strength in the bin.

As an example of an answer product, a pie diagram may be presented for each possible location of a receiver to visualize the relative contribution to the predicted measurement uncertainty due to uncertainty in the subsurface zones. Based on this information, those locations containing relevant information about the reservoir, or more relevant information than other locations, may be selected for the survey. Also, given economic and/or technical constraints on the number and location of the receivers, those locations with the highest contributions from the reservoir and that could generate a good signal may be selected for the survey.

In some embodiments of the invention, relative contributions of different uncertain parameter groups may be used to prioritize certain locations relative to other locations. Put another way, if one location is determined to have a higher contribution to predicted measurement uncertainty in a particular spatial grouping of interest than another location, it may be desirable to select that location over the other location for the survey based upon the higher relative contribution. In some embodiments, this prioritization may be extended to the selection of a group of locations having what may be referred to as the “greatest” or “highest” contributions, e.g., by selecting those locations having the top N uncertainty contributions for a particular uncertain parameter grouping. It will be appreciated, however, by selecting the locations having the “greatest” or “highest” contributions for a survey, some selected locations may not have the absolute highest contributions among all locations under consideration. For example, other concerns, such as obstructions and other economic and/or technical constraints may result in the exclusion of one or more locations under consideration, even when those excluded locations have greater contributions than one or more selected locations. Therefore, any reference to selecting the locations with the “greatest” or “highest” contributions should not be considered to require all of the selected locations to have the largest absolute contributions among the locations under consideration.

### Physical-Property Targeted Design

As noted above, in addition to or lieu of spatial grouping, the uncertain input parameters of the subsurface model may also be grouped according to the physical properties they represent (e.g., porosity, permeability, elastic properties, residual saturations, fluid density). As shown in FIG. 7, using the same example presented earlier in connection with FIG. 5, a similar color map 420 may be generated based on physical properties. Again, color map 420 represents the variance calculated for travel times between given source and receiver. The areas with higher variance are indicated at 422, and the low-variance areas are indicated at 424. The dots 426 indicate possible locations of the receivers.

For each candidate location, GSA may be performed according to the techniques disclosed herein to calculate individual contribution to the total variance of the travel times coming from uncertainties in the pre-defined meta-parameter groups representing specific physical properties. In this example, three parameter groups were considered: porosity, dry-rock bulk modulus, and water saturation S_{w}.

As an example of an answer product, a pie diagram, e.g., pie-diagrams 428a-c, may be presented for each possible location of the receiver, to visualize the contribution to the predicted measurement uncertainty due to uncertainty in the physical properties (e.g., porosity Φ 430, dry-rock bulk modulus K 432 and water saturation S_{w} 434). Based on this information, those locations containing relevant information about physical properties of interest may be selected for the survey. For example, if one is interested in reducing uncertainty in the oil-in-place estimates, the locations containing information about porosity and water saturation may be included in the subsequent survey, since the total oil-in-place estimate may be obtained by integrating Φ(1−S_{w}) over the entire reservoir. Thus, in the example shown in FIG. 7, the most desirable candidate location from among those illustrated may generally be associated with pie-diagram 428c. Again, given economic and/or technical constraints on the number and location of the receivers, those locations with the highest contributions from the physical properties of interest may be selected for the survey. Alternative answer products may include bar charts, line charts, bin diagrams, and others that will be appreciated by those of ordinary skill in the art having the benefit of the instant disclosure.

Embodiments of the invention therefore may be used in some embodiments to assist in the design of a targeted measurement survey under uncertainty based on combining the uncertain parameters of a subsurface model into uncertain parameter groups and performing global sensitivity analysis to determine individual contributions from the uncertain parameter groups to the total variance of the measurement signal. The source-receiver geometry for a survey may be determined based on the target of the design (e.g., reservoir zone of interest, physical property of interest, or a combination thereof) by prioritizing source-receiver pairs having higher uncertainty contributions from the parameter group(s) of interest, e.g., by selecting the source-receiver pairs with the highest uncertainty contribution from the parameter group(s) of interest.

For example, as illustrated in FIG. 8, an example sequence of operations consistent with some embodiments of the invention for performing a targeted survey design is illustrated at 450. First, in block 452, models and realizations may be generated based on the available information for a desired geographical region, e.g., an oilfield associated with a reservoir. Next, in block 454, total variances of the corresponding measurement signal (e.g., seismic, electro-magnetic, gravity, etc.) may be calculated to identify regions and survey geometries with the highest variances for a given time at which the survey is planned. Then, in block 456, global sensitivity analysis may be performed to allocate variances to particular spatial and/or physical property groups by calculating GSA sensitivity indices. Next, in block 458, candidate source-receive pairs may be ranked and filtered based on desired spatial and/or physical property groups in the manner disclosed above. Thereafter, a visualization of candidate source-receiver pairs may be presented to a user, e.g., the color maps disclosed in FIGS. 5 and 7, or any other type of visualizations (e.g., line graphs, bar charts, bin diagrams, tornado diagrams, or other visualizations that will be appreciated by those of ordinary skill in the art having the benefit of the instant disclosure) that represent the relative variances attributable to different spatial and/or physical properties or groups, e.g., elastic properties of the overburden zone 1; hydrocarbon saturation in the reservoir zone 3, or combinations thereof. In the alternative, numerical values of sensitivity indices without any visualization may be presented to a user, or a combination of numerical and graphical information may be presented user in some embodiments.

In another embodiment, if a forward model for the performance metric of the oilfield project is available (e.g., net present value (NPV), total hydrocarbon in place, total hydrocarbon produced), a two-stage GSA can be performed. First, total variances for the performance metric of the project may be calculated as part of block 454. Then global sensitivity analysis may be performed to calculate variance contributions to the predicted performance metric from particular spatial and/or physical property groups (see, for example, U.S. Patent Application Publication No. 2010/0299126 by Chugunov et al., now issued as U.S. Pat. No. 8,548,785, and Chugunov N., Senel O., Ramakrishnan T. S., Reducing Uncertainty in Reservoir Model Predictions: from Plume Evolution to Tool Responses, Presented at the 11th International Conference on Greenhouse Gas Control Technologies (GHGT-11). Kyoto, Japan, Nov. 16-22, 2012 (published in Energy Procedia, Volume 37, 2013, Pages 3687-3698), both of which are incorporated by reference herein in their entireties). Following block 456 as described above, the filtering candidate surveys in block 458 may be based on those survey geometries that contain information (via calculated sensitivity indices) about the particular spatial and/or physical property groups contributing the most uncertainty to the predicted performance metric of the project.

Next, in block 462, one or more candidates for a survey may be selected based upon the generated results to determine a source-receiver geometry for the survey. In some embodiments, the selection may be automated based upon input variables such as number of candidates to select, desired spatial and/or physical properties and/or groups, ranking methodology, etc., whereas in other embodiments, a user may be presented with a visualization and make selections manually based upon the presented visualization. In some embodiments, a report or other information regarding a survey may also be generated and output to the user. Furthermore, in some embodiments, an optimization problem may be solved to identify a set of source-receiver pairs that provide the most information about the targeted group of formation properties under additional technical and/or economic constraints. Design of a targeted survey is then complete.

In another embodiment, multiple surveys planned at multiple times, or multiple surveys planned for simultaneous performance, may be considered at blocks 452 and 454. Thus, embodiments of the invention are not limited to the development of a single survey design at a time.

While particular embodiments have been described, it is not intended that the invention be limited thereto, as it is intended that the invention be as broad in scope as the art will allow and that the specification be read likewise. In addition, it will be appreciated that implementation of the aforementioned functionality in software and thusly in a computer system executing such software would be well within the abilities of one of ordinary skill in the art having the benefit of the instant disclosure. It will therefore be appreciated by those skilled in the art that yet other modifications could be made without deviating from its spirit and scope as claimed.

What is claimed is:

1. A method of designing a targeted survey, the method comprising:
using at least one processor, determining a total variance of a measurement signal at a plurality of locations in a geographical region from a subsurface model;
using the at least one processor, performing global sensitivity analysis to determine individual contributions of a plurality of uncertain parameter groups to the total variance of the measurement signal at the plurality of locations; and
determining a geometry for a survey based on the determined individual contributions.

2. The method of claim 1, wherein determining the geometry for the survey comprises:
determining a total variance of a performance metric of a project from the subsurface model;
performing global sensitivity analysis for the performance metric of the project to identify individual contributions of a second plurality of uncertain parameter groups to the total variance of the performance metric of the project; and
determining a geometry for a survey based on the identified second plurality of uncertain parameter groups contributing to the total variance of the performance metric of the project.

3. The method of claim 1, wherein determining the geometry based on the determined individual contributions includes determining the geometry based on a target.

4. The method of claim 3, wherein the target is a spatial parameter.

5. The method of claim 4, wherein the spatial parameter is a subsurface zone of interest.

6. The method of claim 3, wherein the target is a physical parameter.

7. The method of claim 6, wherein the physical parameter comprises porosity, permeability, elastic properties, residual saturations, fluid density, or combinations thereof.

8. The method of claim 3, wherein the target is a combination of a spatial parameter and a physical parameter.

9. The method of claim 3, wherein at least one parameter group is associated with a spatial parameter.

10. The method of claim 3, wherein at least one parameter group is associated with a physical parameter.

11. The method of claim 3, wherein at least one parameter group is associated with a physical parameter and a spatial parameter.

12. The method of claim 3, wherein determining the geometry based on the determined individual contributions includes selecting a first source-receiver pair over a second source-receiver pair based upon the first source-receiver pair having a higher individual contribution to the total variance associated with the target than the second source-receiver pair.

13. The method of claim 1, further comprising generating a visualization of the individual contributions.

14. The method of claim 13, wherein the visualization includes a color map.

15. The method of claim 13, wherein the visualization includes at least one pie-diagram displaying relative individual contributions at a first location.

16. The method of claim 1, wherein determining the geometry for the survey includes determining a source-receiver geometry for the survey.

17. The method of claim 1, wherein determining the geometry for the survey includes determining a geometry for each of a plurality of surveys, wherein each of the plurality of surveys is a geophysical or a petrophysical survey, and wherein the plurality of surveys are performed simultaneously or at different times.

18. The method of claim 1, further comprising performing the survey based on the determined geometry.

19. An apparatus, comprising:
at least one processor; and
program code configured upon execution by the at least one processor to design a targeted survey by:
determining a total variance of a measurement signal at a plurality of locations in a geographical region from a subsurface model;
performing global sensitivity analysis to determine individual contributions of a plurality of uncertain parameter groups to the total variance of the measurement signal at the plurality of locations; and
determining a geometry for a survey based on the determined individual contributions.

20. A program product, comprising:
a computer readable medium; and
program code stored on the computer readable medium and configured upon execution by at least one processor to design a targeted survey by:
determining a total variance of a measurement signal at a plurality of locations in a geographical region from a subsurface model;
performing global sensitivity analysis to determine individual contributions of a plurality of uncertain parameter groups to the total variance of the measurement signal at the plurality of locations; and
determining a geometry for a survey based on the determined individual contributions.
